(19) United States
(12) Patent Application Publication
(10) Pub. No.: US 2026/0356154 A1
(43) Pub. Date: Nov. 12, 2026

(54) VEHICLE AIR CONDITIONING DEVICE

(71) Applicant: SANDEN CORPORATION, Isesaki-shi, Gunma (JP)

(72) Inventors: Risa NOMURA, Isesaki-shi, Gunma (JP); Takemi NAGAO, Isesaki-shi, Gunma (JP); Hirotaka SAKURAI, Isesaki-shi, Gunma (JP)

(73) Assignee: SANDEN CORPORATION, Isesaki-shi, Gunma (JP)

(21) Appl. No.: 19/135,029

(22) PCT Filed: Nov. 28, 2023
(86) PCT No.: PCT/JP2023/042542

§ 371 Date: Jun. 2, 2025

(30) Foreign Application Priority Data
Dec. 21, 2022 (JP) 2022-204768

(51) Int. Cl. B60H 1/00

(52) U.S. Cl. CPC B60H 1/00064; B60H 1/00835; B60H 2001/00135

(57) ABSTRACT

A vehicle air-conditioning device includes an air introduction unit that selectively introduces inside air and outside air, and an air temperature adjustment unit that adjusts the temperature of air introduced by the air introduction unit. The air temperature adjustment unit has a first passage and a second passage partitioned by a partition, and a filter and a heat exchanger penetrating the partition and extending across the first passage and the second passage. In the vehicle air-conditioning device, the partition includes a first partition on the windward side of the filter and a second partition on the leeward side of the filter, and the first partition position of the first partition closest to the filter is closer to the second passage than the second partition position of the second partition closest to the filter.

### CROSS-REFERENCE TO RELATED APPLICATIONS

This application is a U.S. National Stage Patent Application under 37 U.S.C. § 371 of International Patent Application No. PCT/JP2023/042542, filed on Nov. 28, 2023, which claims the benefit of Japanese Patent Application No. JP 2022-204768, filed on Dec. 21, 2022, the disclosures of each of which are incorporated herein by reference in their entirety.

### TECHNICAL FIELD

The present invention relates to a vehicle air-conditioning device.

### BACKGROUND ART

Conventionally, there has been known a vehicle air-conditioning device in which a conditioned air passage is set to a two-layer flow mode in which a first passage on an outside air side and a second passage on an inside air side are partitioned such that warmed high-temperature inside air is recirculated and blown out from a foot outlet and low-humidity outside air is blown out from a defroster outlet, thereby achieving both improvement in a heating capacity and the antifogging properties of a window glass (see PATENT LITERATURE 1 below).

### CITATION LIST

### Patent Literature

PATENT LITERATURE 1: JP-A-2000-296712

### SUMMARY OF INVENTION

### Problems to be Solved by Invention

The conventional vehicle air-conditioning device that executes the two-layer flow mode is provided with a filter or a heat exchanger (evaporator or heater (indoor condenser or the like)) extending across the first passage and the second passage so as to penetrate a partition that separates the first passage and the second passage. In such a vehicle air-conditioning device, due to its design, there is a case where a difference is provided in a blowing amount or a blowing resistance between the first passage on the outside air side and the second passage on the inside air side. In such a case, if the air quantity of the second passage on the inside air side, where the blowing resistance is relatively great, is set to be greater than the air quantity of the first passage on the outside air side, where the blowing resistance is relatively small, wind leaks from the gap of the penetrating portion of the partition described above, and inside air with a high humidity is mixed into the first passage on the outside air side, which causes a problem of degrading the function of the two-layer flow mode.

On the other hand, in order to enhance the airtightness of the penetrating portion by eliminating the gap of the penetrating portion described above, a clearance for placing the filter and the heat exchanger is eliminated, which causes a problem of degrading the assemblability of the device. In addition, in order to enhance the airtightness of the penetrating portion by providing a sealant in the gap of the penetrating portion described above, there arises a problem that the sealant is deteriorated due to freezing of condensed water in the heat exchanger (evaporator) or the like. For these reasons, there has been demanded a technique of providing the clearance for maintaining favorable assemblability in the penetrating portion of the partition and reducing degradation of the function of the two-layer flow mode due to the wind leakage without using the sealant.

An object of the present invention is to cope with these situations. That is, the object of the present invention is that in a vehicle air-conditioning device that executes a two-layer flow mode, a clearance for maintaining favorable assemblability is provided in a penetrating portion of a partition, and degradation of the function of the two-layer flow mode due to wind leakage is reduced without using a sealant.

### Solution to Problems

A vehicle air-conditioning device according to one aspect of the present invention is a vehicle air-conditioning device including an air introduction unit that selectively introduces inside air and outside air, and an air temperature adjustment unit that adjusts the temperature of air introduced by the air introduction unit. The air temperature adjustment unit has a first passage and a second passage partitioned by a partition, and a filter and a heat exchanger penetrating the partition and extending across the first passage and the second passage, and the partition has a first partition on the windward side of the filter and a second partition on the leeward side of the filter, and the first partition position of the first partition closest to the filter is closer to the second passage than the second partition position of the second partition closest to the filter.

### Effects of Invention

According to the present invention, in the vehicle air-conditioning device that executes the two-layer flow mode, the clearance for maintaining favorable assemblability can be provided in the penetrating portion of the partition, and degradation of the function of the two-layer flow mode due to the wind leakage can be reduced without using the sealant.

### BRIEF DESCRIPTION OF DRAWINGS

FIG. 1 is a side view showing an entire configuration of a vehicle air-conditioning device according to an embodiment of the present invention.

FIG. 2 is a sectional view taken along line A-A in FIG. 1, which shows a two-layer flow mode.

FIG. 3 is an explanatory view showing an internal structure (blowing channel) of a main body case on one side.

FIG. 4 is an explanatory view showing an internal structure (blowing channel) of the main body case on the other side.

FIG. 5 is an explanatory view showing an internal structure (blowing channel) of a main body case on the other side in a first modification.

FIG. 6 is an explanatory view showing an internal structure (blowing channel) of a main body case on the other side in a second modification.

FIG. 7 is an explanatory view showing an internal structure (blowing channel) of a main body case on the other side in a third modification.

### DESCRIPTION OF EMBODIMENTS

Hereinafter, a mode (present embodiment) for carrying out the present invention will be described in detail with reference to the drawings. In the following description, the same reference signs denote portions of the same functions, and redundant descriptions in the drawings are omitted as appropriate.

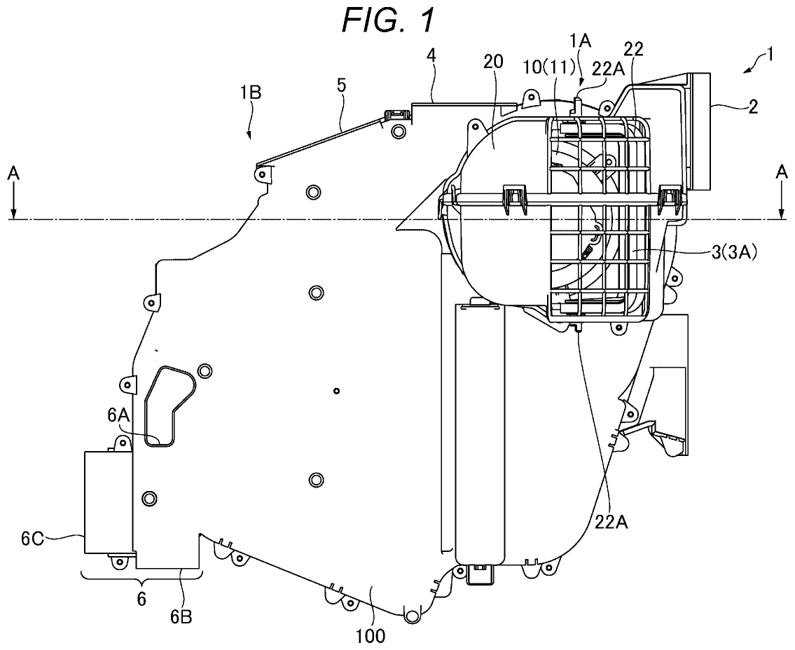

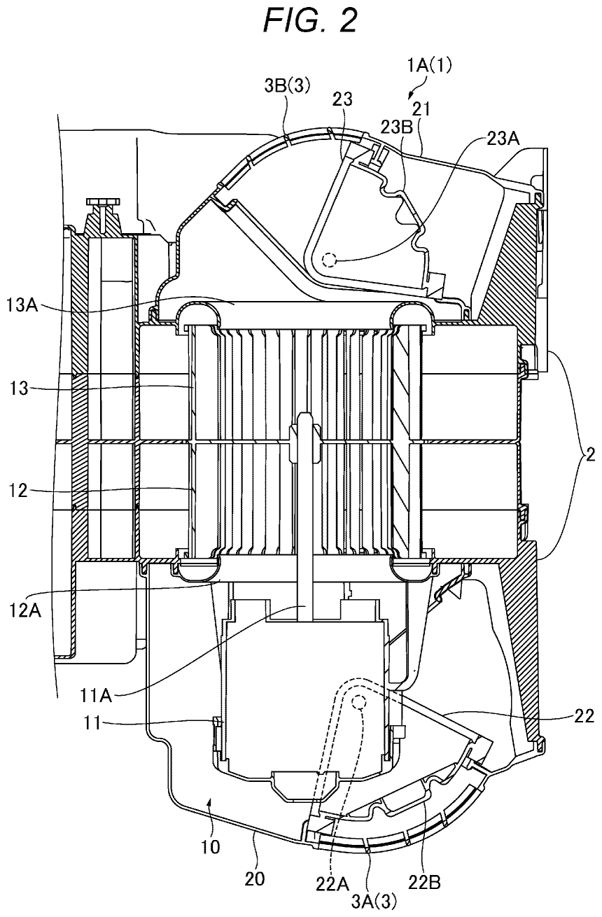

As shown in FIGS. 1 and 2, a vehicle air-conditioning device 1 according to the present embodiment includes, in a main body case 100, an air introduction unit 1A that selectively introduces air (inside air) inside a vehicle compartment and air (outside air) outside a vehicle, and an air temperature adjustment unit 1B that adjusts the temperature of air introduced by the air introduction unit 1A. The air introduction unit 1A is provided with an outside air inlet 2 and an inside air inlet 3(3A, 3B). The air temperature adjustment unit 1B is provided with a first blow-out unit 4, a second blow-out unit 5, and a third blow-out unit 6. Here, the first blow-out unit 4 is, for example, a defroster outlet, the second blow-out unit 5 is, for example, a face outlet, and the third blow-out unit 6 includes, for example, a foot outlet 6A, a foot outlet 6B of a rear seat, a face outlet 6C of the rear seat, and the like.

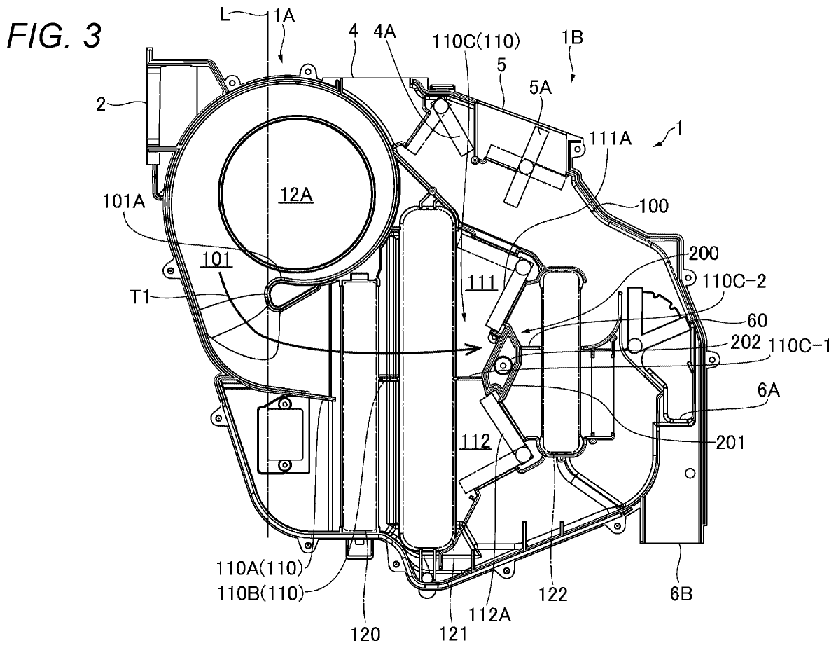

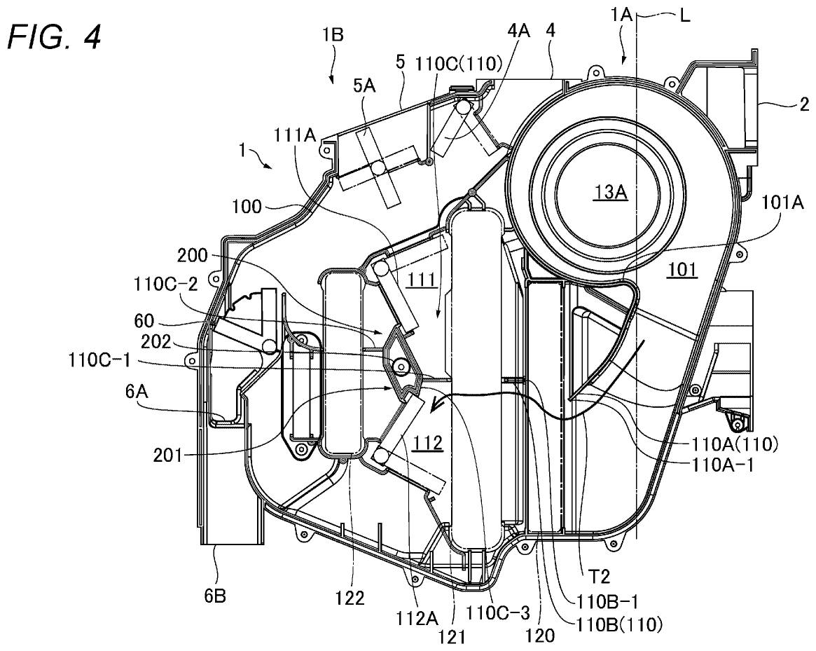

As shown in FIGS. 3 and 4, in the air temperature adjustment unit 1B, a filter 120, an evaporator (cooler) 121 which is one type of heat exchanger, and a heater (indoor condenser or the like) 122 which is one type of heat exchanger are provided so as to penetrate a partition 110 and extend across a first passage (upper layer portion) 111 and a second passage (lower layer portion) 112. The first passage 111 is provided with an upper layer air mix door 111A, and the second passage 112 is provided with a lower layer air mix door 112A.

As shown in FIGS. 1 and 2, the air introduction unit 1A includes a centrifugal blower 10 therein. The centrifugal blower 10 includes a drive unit (motor) 11 and two layers of centrifugal fans 12, 13 coaxially rotated by the drive unit 11. In the centrifugal blower 10, a suction port 12A of one centrifugal fan 12 and a suction port 13A of the other centrifugal fan 13 are opened in opposite directions along a drive shaft 11A.

The air introduction unit 1A further includes intake cases 20, 21. The intake cases 20, 21 are provided so as to cover the pair of suction ports 12A, 13A of the centrifugal blower 10, respectively. One intake case 20 is provided with the inside air inlet 3A, and the other intake case 21 is provided with the inside air inlet 3B. The outside air inlet 2 is provided across the two intake cases 20, 21. When mounted on the vehicle, the outside air inlet 2 is provided so as to be opened toward the front side of the vehicle, and the two inside air inlets 3A, 3B are provided so as to be opened toward the left and right sides in the width direction of the vehicle.

In each of the intake cases 20, 21 provided in the air introduction unit 1A, an inside/outside air switching damper 22, 23 is provided. Each of the inside/outside air switching dampers 22, 23 is a rotary damper including a rotary shaft 22A, 23A, and closes the outside air inlet 2 and opens the inside air inlets 3A, 3B by rotating about the rotary shaft 22A, 23A in one direction, and opens the outside air inlet 2 and closes the inside air inlets 3A, 3B by rotating about the rotary shaft 22A, 23A in the other direction.

In the state shown in FIG. 2, a shield 22B of one inside/outside air switching damper 22 blocks the inside air inlet 3A to close the inside air inlet 3A, and air (outside air) taken in from the outside air inlet 2 through the inside/outside air switching damper 22 is drawn into the suction port 12A, and accordingly, the outside air inlet 2 is opened. Meanwhile, a shield 23B of the other inside/outside air switching damper 23 blocks the outside air inlet 2 to close the outside air inlet 2, and the shield 23B retracts from the inside air inlet 3B to open the inside air inlet 3B, and accordingly, air (inside air) taken in from the inside air inlet 3B is drawn into the suction port 13A. Such a state in FIG. 2 is a two-layer flow state (two-layer flow mode).

Note that although not shown, the shield 22B, 23B of the inside/outside air switching damper 22, 23 blocks the inside air inlet 3A, 3B to close the inside air inlet 3A, 3B, and air (outside air) taken in from the outside air inlet 2 through the inside/outside air switching damper 22, 23 is drawn into the suction port 12A, 13A, and accordingly, an outside air introduction state (outside air mode) in which the outside air inlet 2 is opened is brought.

Although not shown, the shield 22B, 23B of the inside/outside air switching damper 22, 23 blocks the outside air inlet 2 to close the outside air inlet 2, and the shield 22B, 23B of the inside/outside air switching damper 22, 23 retracts from the inside air inlet 3A, 3B to open the inside air inlet 3A, 3B, and accordingly, an inside air introduction state (inside air mode) in which air (inside air) taken in from the inside air inlet 3A, 3B is drawn into the suction port 12A, 13A is brought.

FIGS. 3 and 4 show an internal configuration of the main body case 100 forming the air introduction unit 1A and the air temperature adjustment unit 1B of the vehicle air-conditioning device 1. The main body case 100 includes, in the air introduction unit 1A, a scroll housing 101 of the centrifugal blower 10. The scroll housing 101 forms a scroll-shaped blowing channel for air sucked from the suction ports 12A, 13A in the pair of centrifugal fans 12, 13 (FIG. 2) of the centrifugal blower 10, and a tongue portion 101A is formed closest to the outer peripheries of the centrifugal fans 12, 13.

As shown in FIG. 3, a straight line L passing through the rotary shaft 22A of the inside/outside air switching damper 22 on the drive unit 11 side is disposed on the front side of the vehicle with respect to the tongue portion 101A of the scroll housing 101 provided in the centrifugal blower 10. With this configuration, even in a case where the dimension of the inside/outside air switching damper 22 in the height direction thereof is minimized to the extent necessary, the rotary shaft 22A does not interfere with the tongue portion 101A. Thus, the dimension of the inside/outside air switching damper 22 in the height direction thereof can be set to the minimum necessary while blowing performance is ensured by placing the tongue portion 101A at an appropriate position.

In FIGS. 3 and 4, the flow of air (wind) in the main body case 100 will be described. The main body case 100 includes therein a first opening/closing door 4A that opens and closes the first blow-out unit 4, a second opening/closing door 5A that opens and closes the second blow-out unit 5, and a wind direction switching door 60 that switches the wind direction of the foot outlet 6A of the third blow-out unit 6. The inside of the air temperature adjustment unit 1B in the main body case 100 is partitioned into the first passage (upper layer portion) 111 and the second passage (lower layer portion) 112 by the partition 110.

In the air introduction unit 1A, the scroll housing 101 connected to one centrifugal fan 12 of the centrifugal blower 10 is a blowing channel for blowing air introduced by the centrifugal fan 12 into the first passage (upper layer portion) 111. The scroll housing 101 connected to the other centrifugal fan 13 is a blowing channel for blowing air introduced by the centrifugal fan 13 into the second passage (lower layer portion) 112. As shown in FIGS. 3 and 4, the pair of centrifugal fans 12, 13 (pair of suction ports 12A, 13A) of the centrifugal blower 10 is disposed apart from the second passage 112 and close to the first passage 111. Thus, in the air introduction unit 1A, the length of the scroll housing 101 (blowing channel) connecting the centrifugal fan 13 and the second passage 112 to each other is longer than the length of the scroll housing 101 (blowing channel) connecting the centrifugal fan 12 and the first passage 111 to each other.

In the two-layer flow state (two-layer flow mode), outside air sucked through the outside air inlet 2 at the suction port 12A of the centrifugal fan 12 flows through the scroll housing 101 and is introduced into the first passage (upper layer portion) 111, for example, as indicated by the direction of an arrow T1 in FIG. 3. For example, such outside air is blown from the first blow-out unit 4 (for example, defroster outlet). The outside air sucked at the suction port 12A has a relatively-low humidity, and in the two-layer flow mode, the outside air is blown out from the defroster outlet, and therefore, the antifogging properties of a window glass are achieved.

In the two-layer flow mode, inside air sucked through the inside air inlet 3A at the suction port 13A of the centrifugal fan 13 flows through the scroll housing 101 and is introduced into the second passage (lower layer portion) 112, for example, as indicated by the direction of an arrow T2 in FIG. 4. The inside air is blown out from the third blow-out unit 6 (e.g., the foot outlet 6A, the foot outlet 6B of the rear seat, and the like). Since the inside air sucked at the suction port 13A is taken in from the inside of the vehicle compartment, the inside air has a relatively-high temperature (and a high humidity), and in the two-layer flow mode, the inside air is recirculated and blown out from the foot outlet 6A and the like. Thus, a heating capacity is improved.

Note that in the outside air mode, outside air sucked through the outside air inlet 2 at the suction port 12A of the centrifugal fan 12 is introduced into the first passage (upper layer portion) 111, and outside air sucked through the outside air inlet 2 at the suction port 13A of the centrifugal fan 13 is introduced into the second passage (lower layer portion) 112.

In the inside air mode, inside air sucked through the inside air inlet 3A at the suction port 12A of the centrifugal fan 12 is introduced into the first passage (upper layer portion) 111, and inside air sucked through the inside air inlet 3B at the suction port 13A of the centrifugal fan 13 is introduced into the second passage (lower layer portion) 112.

The partition 110 has a first partition 110A and a second partition 110B. In FIGS. 3 and 4, the first partition 110A is located on the windward side (upstream side) of the filter 120, and extends obliquely along the extending direction of the scroll housing 101. The second partition 110B is located on the leeward side (downstream side) of the filter 120, and extends along a blowing direction (i.e., a direction substantially perpendicular to the extending direction of the filter 120 shown in FIGS. 3 and 4).

The partition 110 is provided with a third partition 110C on the leeward side of the evaporator 121 provided on the leeward side of the filter 120. The third partition 110C is provided between the evaporator 121 and the heater 122 provided on the leeward side of the evaporator 121.

The third partition 110C shown in FIGS. 3 and 4 has a partition wall 110C-1 and a partition wall 110C-2 extending along the blowing direction (i.e., in a direction substantially perpendicular to the extending direction of the evaporator 121 shown in FIGS. 3 and 4), and a surrounding wall portion 200. The surrounding wall portion 200 is provided, in a surrounding partition wall 201, with a fixing portion 202 for fixing a plurality of divided casings forming the main body case 100. In the third partition 110C, a partition wall 110C-3 partially forming the surrounding partition wall 201 functions as a wind guide that guides wind (inside air) flowing in the vicinity of the partition 110 in the second passage (lower layer portion) 112 toward the second passage 112.

The vehicle air-conditioning device 1 is designed to have gaps (clearances) between the first partition 110A and the filter 120, between the filter 120 and the second partition 110B, between the second partition 110B and the evaporator 121, between the evaporator 121 and the partition wall 110C-1 of the third partition 110C, and between the partition wall 110C-2 of the third partition 110C and the heater 122 in order to maintain favorable assemblability when the filter 120, the evaporator 121, and the heater 122 are assembled with penetrating the partition 110.

The vehicle air-conditioning device 1 is designed such that the third blow-out unit 6 (foot outlet 6A, foot outlet 6B of the rear seat) located in the second passage (lower layer portion) 112 has an outlet opening area smaller than the outlet opening area of the first blow-out unit 4 (e.g., defroster outlet) located in the first passage (upper layer portion) 111. Thus, in the two-layer flow mode, blowing resistance when inside air sucked at the suction port 13A is blown through the second passage 112 is greater than blowing resistance when outside air sucked at the suction port 12A is blown through the first passage 111. In this two-layer flow mode, inside air flows through the second passage 112 having relatively-great blowing resistance with a greater air quantity than that of outside air flowing through the first passage 111 having relatively-small blowing resistance.

Thus, in the two-layer flow mode, the pressure (wind pressure) of inside air flowing through the second passage 112 is higher than the pressure (wind pressure) of outside air flowing through the first passage 111. Thus, in a state in which the gaps are provided in the penetrating portions of the partition 110 and the filter 120, the evaporator 121, and the heater 122 are attached thereto, in a case where no countermeasure is taken, the high-pressure inside air flowing through the second passage 112 easily flows toward the first passage 111 through the gaps.

If inside air with a relatively-high humidity in the second passage 112 leaks into the first passage 111 through the gap in the penetrating portion of the partition 110, the humidity of outside air blown out from the first blow-out unit 4 (defroster outlet) increases, which may lower the antifogging properties of the window glass. In the vehicle air-conditioning device 1, the configuration of the partition 110 is devised in order to prevent inside air from leaking from the second passage 112 into the first passage 111 through these gaps.

Specifically, as shown in FIG. 4, in the partition 110 provided in the vehicle air-conditioning device 1, the first partition position 110A-1 of the first partition 110A closest to the filter 120 is closer to the second passage (lower layer portion) 112 than the second partition position 110B-1 of the second partition 110B closest to the filter 120. The first partition 110A has an inclined portion obtained by extending the scroll-shaped blowing channel formed by the scroll housing 101 in the air introduction unit 1A to the first partition position 110A-1, and extends obliquely along the extending direction of the scroll housing 101. That is, in the direction shown in FIG. 4, the first partition 110A is inclined such that a leeward-side end portion (first partition position 110A-1) thereof is located closer to the second passage 112 than a windward-side end portion (connected to the scroll housing 101).

Accordingly, wind (inside air) sucked at the suction port 13A, introduced into the second passage 112 through the scroll housing 101, and flowing in the vicinity of the partition 110 flows in a direction apart from the partition 110 as indicated by the arrow T2 in FIG. 4.

Further, since the first partition position 110A-1 of the first partition 110A is closer to the second passage 112 than the second partition position 110B-1 of the second partition 110B, the air quantity of outside air introduced into the first passage 111 increases and the air quantity of inside air introduced into the second passage 112 decreases as compared with a case where the first partition position 110A-1 is at the same position as the second partition position 110B-1 in the extending direction of the filter 120 shown in FIG. 4.

From these points, the vehicle air-conditioning device 1 prevents inside air in the second passage 112 from leaking into first passage 111 through the gaps (clearances) of the partition 110.

Note that even when the first partition position 110A-1 of the first partition 110A is closer to the second passage 112 than the second partition position 110B-1 of the second partition 110B, the total air quantity of the air quantity of outside air blown out from the first passage 111 side and the air quantity of inside air blown out from the second passage 112 side is substantially the same as that in a case where the first partition position 110A-1 and the second partition position 110B-1 are at the same position in the extending direction of the filter 120 shown in FIG. 4. That is, the vehicle air-conditioning device 1 prevents inside air in the second passage 112 from leaking into the first passage 111 without changing the overall air quantity of air blown out from the air temperature adjustment unit 1B.

In the vehicle air-conditioning device 1, as indicated by the arrow T2 in FIG. 4, even when wind (inside air) flowing in the direction apart from the partition 110 by the first partition 110A passes through the filter 120 and then approaches the partition 110 on the windward side or leeward side of the evaporator 121, the air flows along the partition wall 110C-1 of the third partition 110C on the leeward side of the evaporator 121 in the second passage 112, is then guided to the partition wall 110C-3 (wind guide), and flows in the direction apart from the partition 110 again.

In the vehicle air-conditioning device 1, since the partition 110 includes the third partition 110C having such a configuration, this further prevents inside air in the second passage 112 from leaking into the first passage 111 through the gaps (clearances) of the partition 110.

In the second passage 112 of the vehicle air-conditioning device 1 as described above, inside air flows to the leeward side while maintaining a state (pressure difference between outside air and inside air) in which inside air is higher in pressure than outside air in the first passage 111 (i.e., while reducing the leakage of inside air into the first passage 111).

As described above, according to the vehicle air-conditioning device 1, the clearances that maintain favorable assemblability are provided in the penetrating portions of the partition 110, and the leakage of inside air (wind leakage) from the second passage (lower layer portion) 112 to the first passage (upper layer portion) 111 can be prevented without using a sealant. That is, according to the vehicle air-conditioning device 1, since mixing of inside air into outside air in the first passage 111 is prevented at the time of executing the two-layer flow mode, it is possible to reduce degradation of the function of the two-layer flow mode due to the wind leakage.

In the scroll housing 101 on the suction port 12A side as shown in FIG. 3, the leeward side (downstream side) of the tongue portion 101A communicates with the first passage (upper layer portion) 111, and in the scroll housing 101 on the suction port 13A side as shown in FIG. 4, the leeward side of the tongue portion 101A communicates with the second passage (lower layer portion) 112.

Air sucked through the suction port 12A passes through the tongue portion 101A of the scroll housing 101 as described above, enters the first passage (upper layer portion) 111, passes through the filter 120 and the evaporator 121 placed in the main body case 100, and then the air-blowing path is switched by the upper layer air mix door 111A.

At this time, air is blown to the first blow-out unit 4, the second blow-out unit 5, or the third blow-out unit 6 as it is (without passing through the heater 122) when the upper layer air mix door 111A is in a state indicated by a solid line in the figure, and air is blown to the first blow-out unit 4, the second blow-out unit 5, or the third blow-out unit 6 by way of the heater 122 when the upper layer air mix door 111A is in a state indicated by a dash-dotted line in the figure.

Meanwhile, air sucked through the suction port 13A passes through the tongue portion 101A of the scroll housing 101 as described above, enters the second passage (lower layer portion) 112, passes through the filter 120 and the evaporator 121 placed in the main body case 100, and then the air-blowing path is switched by the lower layer air mix door 112A.

At this time, air is blown to the first blow-out unit 4, the second blow-out unit 5, or the third blow-out unit 6 as it is (without passing through the heater 122) when the lower layer air mix door 112A is in a state indicated by a solid line in the figure, and air is blown to the first blow-out unit 4, the second blow-out unit 5, or the third blow-out unit 6 by way of the heater 122 when the lower layer air mix door 112A is in a state indicated by a dash-dotted line in the figure.

According to the vehicle air-conditioning device 1 having such a feature, in the air introduction unit 1A, the outside air inlet 2 is disposed on the front side of the vehicle, the inside air inlet 3 (3A, 3B) is disposed in the vehicle width direction, and the inside/outside air switching dampers 22, 23 are the rotary dampers in which the rotary shafts 22A, 23A are directed in the up-down direction, so that the up-down dimension of the vehicle air-conditioning device 1 can be kept small.

The drive unit 11 of the centrifugal blower 10 in the air introduction unit 1A is disposed so as to overlap with the straight line L passing through the rotary shaft 22A of the inside/outside air switching damper 22, and part of the drive unit 11 is housed inside the inside/outside air switching damper 22, so that the air introduction unit 1A can be reduced in size in the vehicle width direction. In this case, since the rotary shaft 22A of the inside/outside air switching damper 22 is disposed above and below the drive unit 11 of the centrifugal blower 10, the height of the inside/outside air switching damper 22 can be sufficiently increased with respect to the suction port 12A of the centrifugal blower 10, and favorable suction performance of the centrifugal blower 10 can be ensured.

Further, since the rotary shafts 22A, 23A of the inside/outside air switching dampers 22, 23 are provided on the front side of the vehicle with respect to the tongue portion 101A of the scroll housing 101 of the centrifugal blower 10, it is easy to ensure clearances between the inside/outside air switching dampers 22, 23 and an attachment flange of the drive unit 11 of the centrifugal blower 10, and it is easy to attach and detach the drive unit 11 while avoiding interference with the inside/outside air switching dampers 22, 23.

In the arrangement example shown in FIGS. 3 and 4, since the filter 120 does not overlap with the intake cases 20, 21 and the inside/outside air switching dampers 22, 23, the filter 120 can be easily detached, and maintainability is improved.

Hereinafter, first to third modifications of the present embodiment will be described. Note that description of the same contents as those of the above-described embodiment will be omitted in the first to third modifications.

### First Modification

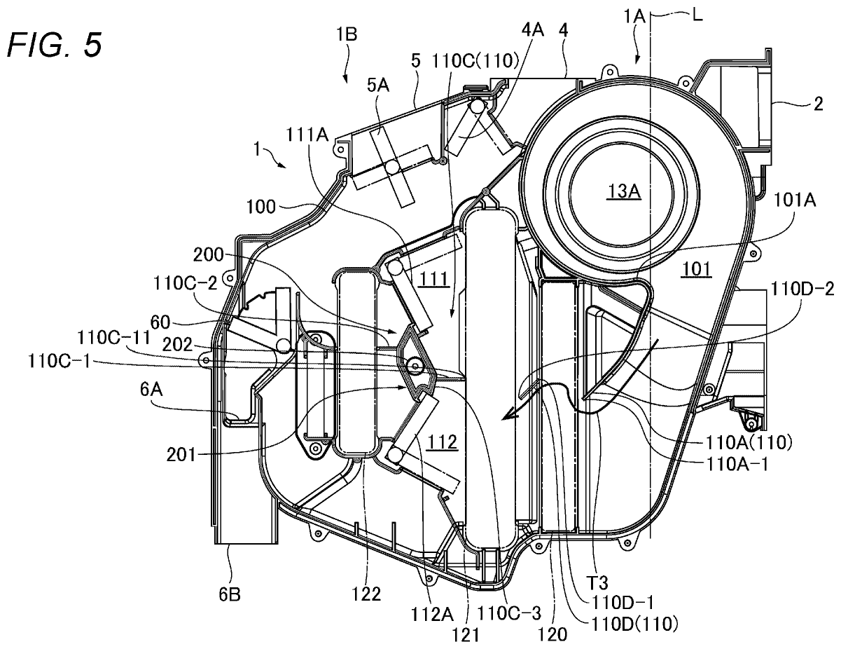

In the first modification, as shown in FIG. 5, in the main body case 100, a second partition 110D is provided instead of the second partition 110B of the example of FIG. 4 described above. In the first modification, the first partition position 110A-1 of the first partition 110A closest to the filter 120 is closer to the second passage (lower layer portion) 112 than the second partition position 110D-1 of the second partition 110D closest to the filter 120. The second partition 110D is inclined such that a leeward-side end portion (partition position 110D-2 described later) thereof is located closer to the second passage 112 than a windward-side end portion (second partition position 110D-1) in a direction shown in FIG. 5.

In the first modification described above, as indicated by an arrow T3 in FIG. 5, wind (inside air) sucked at the suction port 13A, introduced into the second passage (lower layer portion) 112 through the scroll housing 101, and flowing in the vicinity of the partition 110 flows in a direction apart from the partition 110 by the first partition 110A. Even when such inside air approaches the partition 110 when passing through the filter 120, the inside air flows again in the direction apart from the partition 110 by the inclined second partition 110D located on the leeward side of the filter 120.

Further, in the first modification, the partition position 110C-11 of the partition wall 110C-1 of the third partition 110C closest to the evaporator 121 is closer to the first passage (upper layer portion) 111 than the partition position 110D-2 of the second partition 110D closest to the evaporator 121. With this configuration, even when wind (inside air) having passed through the evaporator 121 approaches the first passage 111, the air flows along the partition wall 110C-1 in the second passage 112, is then guided toward the second passage 112 by the partition wall 110C-3 as the wind guide, and flows in the direction apart from the partition 110.

According to the first modification, since the partition 110 has such a configuration, this further prevents inside air in the second passage 112 from leaking into the first passage 111 through the gaps (clearances) of the partition 110. Also in the first modification, since mixing of inside air into outside air in the first passage 111 is prevented at the time of executing the two-layer flow mode, it is possible to reduce degradation of the function of the two-layer flow mode due to the inside air leakage.

### Second Modification

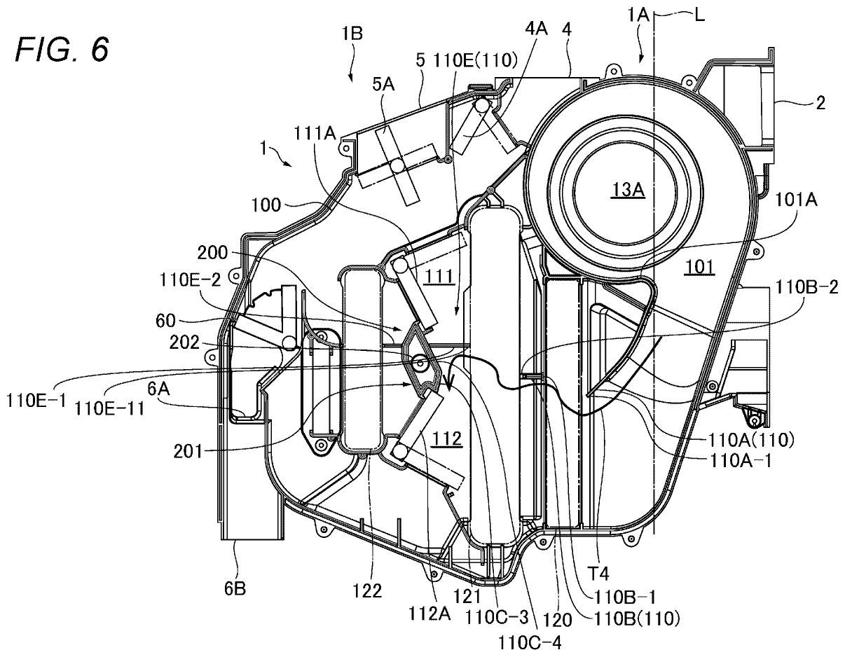

In the second modification, as shown in FIG. 6, in the main body case 100, a third partition 110E is provided instead of the third partition 110C of the example of FIG. 4 described above. The third partition 110E has a partition wall 110E-1 and a partition wall 110E-2 extending along the blowing direction (i.e., in a direction substantially perpendicular to the extending direction of the evaporator 121 shown in FIG. 6). The partition wall 110E-1 (particularly the partition position 110E-11 thereof closest to the evaporator 121) is closer to the first passage (upper layer portion) 111 than the second partition 110B (particularly the partition position 110B-2 thereof closest to the evaporator 121). With this configuration, in the third partition 110E, the partition wall 110C-3 and a partition wall 110C-4 partially forming the surrounding partition wall 201 function as a wind guide that guides wind (inside air) flowing in the vicinity of the partition 110 in the second passage (lower layer portion) 112 toward the second passage 112.

Since the partition wall 110E-1 of the third partition 110E is located closer to the first passage (upper layer portion) 111, the volume of the second passage (lower layer portion) 112 on the leeward side of the evaporator 121 is greater. Thus, on the leeward side of the evaporator 121, the blowing pressure of inside air which is about to flow toward the partition 110 decreases, so that the leakage toward the first passage 111 through the gaps (clearances) of the partition 110 is further prevented.

In the second modification described above, as indicated by an arrow T4 in FIG. 6, wind (inside air) sucked at the suction port 13A, introduced into the second passage (lower layer portion) 112 through the scroll housing 101, and flowing in the vicinity of the partition 110 flows in a direction apart from the partition 110 by the first partition 110A. It is assumed that thereafter, the inside air approaches the partition 110 when passing through the filter 120 and flows toward the first passage (upper layer portion) 111 when passing through the evaporator 121. Even in this case, such inside air flows along the partition wall 110E-1 in the second passage 112, is then guided toward the second passage 112 by the partition wall 110C-3 and the partition wall 110C-4 as the wind guide, and flows in the direction apart from the partition 110.

According to the second modification, since the partition 110 has such a configuration, this further prevents inside air in the second passage 112 from leaking into the first passage 111 through the gaps (clearances) of the partition 110. Also in the second modification, since mixing of inside air into outside air in the first passage 111 is prevented at the time of executing the two-layer flow mode, it is possible to reduce degradation of the function of the two-layer flow mode due to the inside air leakage.

### Third Modification

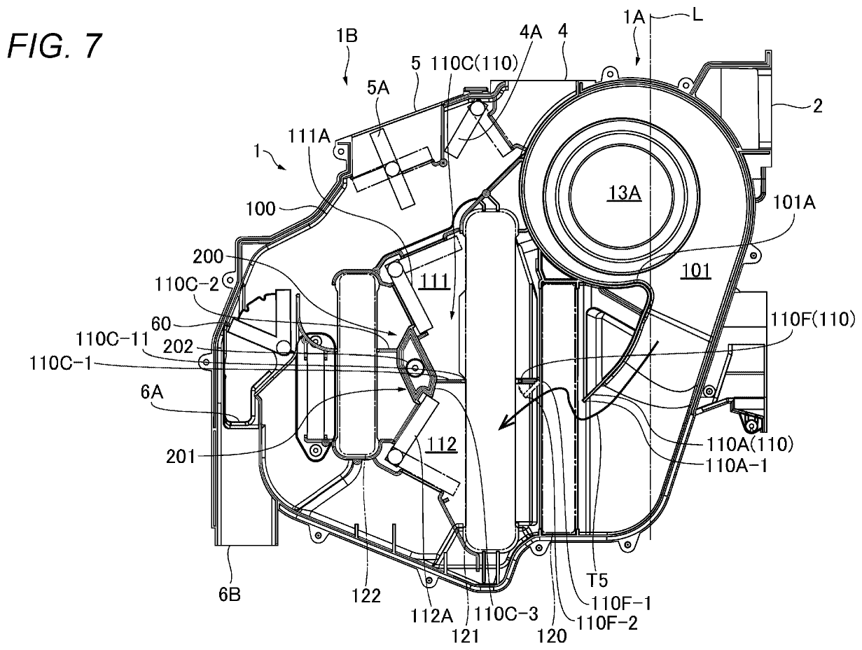

In the third modification, as shown in FIG. 7, in the main body case 100, a second partition 110F is provided instead of the second partition 110B of the example of FIG. 4 described above. The second partition 110F has the structure of a damper that rotates about a rotary shaft 110F-1. The direction of the second partition 110F is switched between a state when the two-layer flow mode is executed in the vehicle air-conditioning device 1 and other states.

For example, at the time of executing the outside air mode in which outside air is introduced into both the first passage 111 and the second passage 112 or at the time of executing the inside air mode in which inside air is introduced into both the first passage 111 and the second passage 112, the problem that the outside air and the inside air in the first passage 111 are mixed does not occur. Thus, in the third modification, when the vehicle air-conditioning device 1 is in a state other than the two-layer flow mode (e.g., when the outside air mode is executed or when the inside air mode is executed), the second partition 110F is disposed so as to extend in a direction substantially perpendicular to the extending direction of the filter 120 shown in FIG. 7.

On the other hand, when the vehicle air-conditioning device 1 is in the two-layer flow mode, the second partition 110F rotates about the rotary shaft 110F-1, and is inclined such that a leeward-side end portion (partition position 110F-2) thereof is closer to the second passage 112 than a windward-side end portion (rotary shaft 110F-1) in the direction shown in FIG. 7 (state indicated by a dash-dotted line in the figure). At the time of executing this two-layer flow mode, the partition position 110C-11 of the partition wall 110C-1 of the third partition 110C closest to the evaporator 121 is closer to the first passage (upper layer portion) 111 than the partition position 110F-2 of the second partition 110F closest to the evaporator 121.

In the third modification described above, at the time of executing the two-layer flow mode, as indicated by an arrow T5 in FIG. 7, wind (inside air) sucked at the suction port 13A, introduced into the second passage (lower layer portion) 112 through the scroll housing 101, and flowing in the vicinity of the partition 110 flows in a direction apart from the partition 110 by the first partition 110A. Even when such inside air approaches the partition 110 when passing through the filter 120, the inside air flows again in the direction apart from the partition 110 by the inclined second partition 110F located on the leeward side of the filter 120.

Thereafter, even when the inside air having passed through the evaporator 121 approaches the first passage 111, the air flows along the partition wall 110C-1 in the second passage 112, is then guided toward the second passage 112 by the partition wall 110C-3 as the wind guide, and flows in the direction apart from the partition 110.

According to the third modification, since the partition 110 has such a configuration, the inclination of the second partition 110F as the damper structure is changed only when the two-layer flow mode in which it is necessary to prevent mixing of inside air into outside air is executed. This prevents inside air in the second passage 112 from leaking into the first passage 111 through the gaps (clearances) of the partition 110. Also in the third modification, since the mixing of inside air into outside air in the first passage 111 is prevented in the two-layer flow mode, it is possible to reduce degradation of the function of the two-layer flow mode due to the inside air leakage.

Although the present embodiment and the modifications thereof have been described above in detail with reference to the drawings, the specific configuration is not limited to the above-described examples, and modifications and the like in design without departing from the gist of the present invention are also included in the present invention.

The first partition 110A of the above-described embodiment (and the first to third modifications) has the configuration extending obliquely along the extending direction of the scroll housing 101, but is not limited to such a configuration. The first partition position 110A-1 of the first partition 110A closest to the filter 120 is only required to be closer to the second passage 112 than the second partition position 110B-1 of the second partition 110B closest to the filter 120. As long as the first partition 110A has such a configuration, for example, the first partition 110A may be disposed so as to extend in the direction substantially perpendicular to the extending direction of the filter 120 shown in FIG. 4.

The first partition 110A of the above-described embodiment (and the first to third modifications) is separated from the scroll housing 101, but is not limited thereto and may be integrated with the scroll housing 101. That is, the leeward-side end portion of the scroll housing 101 may function as the first partition 110A.

### LIST OF REFERENCE SIGNS

1 Vehicle air-conditioning device
1A Air introduction unit
1B Air temperature adjustment unit
2 Outside air inlet
3, 3A, 3B Inside air inlet
4 First blow-out unit
4A First opening/closing door
5 Second blow-out unit
5A Second opening/closing door
6 Third blow-out unit
6A Foot outlet
6B Foot outlet of rear seat
6C Face outlet of rear seat
10 Centrifugal blower
11 Drive unit
11A Drive shaft
12, 13 Centrifugal fan
12A, 13A Suction port
20, 21 Intake case
22, 23 Inside/outside air switching damper
22A, 23A Rotary shaft
22B, 23B Shield
60 Wind direction switching door
100 Main body case
101 Scroll housing
101A Tongue portion
110 Partition
110A First partition
110A-1 First partition position
110B, 110D, 110F Second partition
110B-1, 110D-1 Second partition position
110B-2, 110C-11, 110D-2, 110E-11, 110F-2 Partition position
110C, 110E Third partition
110C-1, 110C-2, 110C-3, 110C-4, 110E-1, 110E-2 Partition wall
110F-1 Rotary shaft
111 First passage
111A Upper layer air mix door
112 Second passage
112A Lower layer air mix door
120 Filter
121 Evaporator
122 Heater
200 Surrounding wall portion
201 Surrounding partition wall
202 Fixing portion

1. A vehicle air-conditioning device comprising:
an air introduction unit that selectively introduces inside air and outside air; and
an air temperature adjustment unit that adjusts a temperature of air introduced by the air introduction unit,
wherein the air temperature adjustment unit has a first passage and a second passage partitioned by a partition, and a filter and a heat exchanger penetrating the partition and extending across the first passage and the second passage, and
the partition has a first partition on a windward side of the filter and a second partition on a leeward side of the filter, and a first partition position of the first partition closest to the filter is closer to the second passage than a second partition position of the second partition closest to the filter.

2. The vehicle air-conditioning device according to claim 1, wherein the first partition has an inclined portion obtained by extending a scroll-shaped blowing channel in the air introduction unit to the first partition position.

3. The vehicle air-conditioning device according to claim 1, wherein
the partition includes a third partition on a leeward side of the heat exchanger provided on a leeward side of the filter, and
a partition position of the third partition closest to the heat exchanger is closer to the first passage than a partition position of the second partition closest to the heat exchanger.

4. The vehicle air-conditioning device according to claim 3, wherein the third partition has a wind guide that guides wind flowing in a vicinity of the partition in the second passage to the second passage.

5. The vehicle air-conditioning device according to claim 1, wherein the air introduction unit has a pair of blowers disposed apart from the second passage and close to the first passage, and has a blowing channel in which air introduced by one of the blowers is blown to the first passage, and a blowing channel in which air introduced by the other blower is blown to the second passage.

6. The vehicle air-conditioning device according to claim 1, wherein
the first passage is provided with a defroster outlet through which introduced outside air is blown out, and
the second passage is provided with a foot outlet through which introduced inside air is blown out.
